(19) United States
(12) Patent Application Publication
(10) Pub. No.: US 2026/0238882 A1
(43) Pub. Date: Aug. 13, 2026

(54) Ear Appliance

(71) Applicant: Kevin P. Grundy, Emmett, ID (US)

(72) Inventor: Kevin P. Grundy, Emmett, ID (US)

(21) Appl. No.: 19/534,969

(22) Filed: Feb. 10, 2026

Related U.S. Application Data
(60) Provisional application No. 63/758,081, filed on Feb. 13, 2025.

(51) Int. Cl. H04N 23/66; G06F 3/01; G06T 17/00; H04N 13/239; H04R 1/10

(52) U.S. Cl. CPC H04N 23/66; G06F 3/012; G06F 3/017; G06T 17/00; H04N 13/239; H04R 1/1041; H04R 2460/03

(57) ABSTRACT

Systems and methods are described for ear-attached multi-sensor devices (Ear Appliances). In one example, an Ear Appliance is designed to be attached solely to an ear of a user and has integrated therewith a visual spectrum imager, which may may be controlled through head gestures and/or verbal commands from the user. In some examples, operations of the Ear Appliance, such as powering up the Ear Appliance and instructing it to take either single images or videos may be achieved without requiring a user display or the use of hands. Tasks such as searching for specific objects or measuring the volume of objects may be achieved, for example, through head movement (i.e., scanning) of the user, with or without additional guidance via audio from the user. Additional sensors may also be integrated with or modularly attached or clipped to the Ear Appliance.

### CROSS-REFERENCE TO RELATED APPLICATIONS

This application claims the benefit of priority of U.S. Provisional Application No. 63/758,081, filed on Feb. 13, 2025, which is hereby incorporated by reference in its entirety for all purposes.

### BACKGROUND

### Field

Various embodiments of the present disclosure generally relate to wearable sensors on ears. In particular, some embodiments relate to an Ear Appliance capable of responding to head gestures or verbal commands, capturing and processing video and/or still images of items in the field of view in front of the user and/or searching for items of interest.

### Description of the Related Art

Wearable computing and head-mounted display devices have advanced rapidly over the past decade. Conventional smart glasses combine a frame-mounted display or optical combiner, a miniaturized projector or waveguide, onboard processors, cameras, microphones, inertial measurement units (IMUs), wireless radios, and input mechanisms (touchpads, voice control, or gesture sensing). Applications include navigation, hands-free information access, remote assistance, industrial workflows, health monitoring, and consumer AR experiences.

### SUMMARY

Systems and methods are described for ear-attached multi-sensor devices (Ear Appliances). According to one embodiment, an Ear Appliance may include an imager, a microphone, a speaker, a processing resource, and instructions that when executed by the processing resource cause the ear appliance to record images and audio on the ear appliance, in which the ear appliance attaches only to a first ear of a user. In some examples, the ear appliance may also include a modular attachment or clip means though which one or more additional or auxiliary modules may be added to increase functionality of the ear appliance.

Other features of embodiments of the present disclosure will be apparent from accompanying drawings and detailed description that follows.

### BRIEF DESCRIPTION OF THE DRAWINGS

Embodiments of the present disclosure are illustrated by way of example, and not by way of limitation, in the figures of the accompanying drawings and in which:

FIG. 1 illustrates an Ear Appliance with multiple sensors controlled by audio commands and head gestures in accordance with an embodiment of the present disclosure.

FIG. 2 illustrates an Ear Appliance searching for specific objects in accordance with an embodiment of the present disclosure.

FIG. 3 illustrates an Ear Appliance in accordance with an embodiment of the present disclosure.

FIG. 4 illustrates various components of an Ear Appliance and a simple data collection sequence in accordance with an embodiment of the present disclosure.

FIG. 5 illustrates an Ear Appliance invocation through gesture in accordance with an embodiment of the present disclosure.

FIG. 6 illustrates an Ear Appliance generating points clouds through head movement reconstruction in accordance with an embodiment of the present disclosure.

FIG. 7 illustrates exemplary containers for holding classes of objects in accordance with an embodiment of the present disclosure.

FIG. 8 illustrates an Ear Appliance attachment system in accordance with an embodiment of the present disclosure.

FIG. 9 illustrates Ear Appliance auxiliary modules in accordance with an embodiment of the present disclosure.

FIG. 10 illustrates direct communication between multiple Ear Appliances in accordance with an embodiment of the present disclosure.

FIG. 11 illustrates Ear Appliance remote processing in accordance with an embodiment of the present disclosure.

FIG. 12 illustrates an electrostatic Ear Appliance hair avoider in accordance with an embodiment of the present disclosure.

FIG. 13 illustrates a mechanical Ear Appliance hair avoider in accordance with an embodiment of the present disclosure.

FIG. 14 illustrates the use of Ear Appliance AI Agents in accordance with an embodiment of the present disclosure.

FIG. 15 illustrates the use of an Ear Appliance to detect and blind proximate image recording devices.

### DETAILED DESCRIPTION

Systems and methods are described for ear-attached multi-sensor devices (Ear Appliances). Non-audio sensor devices are not normally associated with ears. However, because the ear is situated in a fixed relationship to the eyes, it is possible and desirable to take advantage of this physical relationship and use the eye to guide, instruct and operate an Ear Appliance in multiple tasks outside of audio sensors attached to the ear. For example, incorporating a visual spectrum imager in an appliance which is attached to the ear can be controlled through head gestures and/or verbal commands from the person wearing the appliance. In some examples, operations such as powering up the Ear Appliance and instructing it to take either single images or videos are achieved without a user display or the use of hands. Tasks such as searching for specific objects or measuring the volume of objects can be achieved through a person's head movement (i.e., scanning) guided via audio to the person from the Ear Appliance. The number and types of sensors (outside of the audio spectrum) which can be embodied into an Ear Appliance is unlimited. The use of Artificial Intelligence (AI) agents (e.g., through audio interaction with a user) to facilitate the control of the Ear Appliance simplifies Ear Appliance operation and movement.

While the most cost-effective use of an Ear Appliance can be a single unit in or attached to an ear, multiple use cases of one or more Ear Appliances are envisioned. For example, a single user may wear two Ear Appliances (Left and Right ears). Furthermore, Ear Appliances may be networked together between multiple users to generate multi-dimensional area maps of objects and their volumes through AI generated coordinated movement by all participants.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

Depending on the particular context, the terms “component”, “module”, “system,” and the like as used herein are intended to refer to a computer-related entity, either software-executing general-purpose processor, hardware, firmware and a combination thereof. For example, a component may be, but is not limited to being, a process running on a hardware processor, a hardware processor, an object, an executable, a thread of execution, and/or a program. By way of illustration, both an application or agent running on a processing resource and the processing resource can be a component. One or more components may reside within a process and/or thread of execution, and a component may be localized on one Ear Appliance and/or distributed between two or more Ear Appliances. Also, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “processing resource” is used in its broadest sense to mean one or more hardware processors capable of executing instructions. Non-limiting examples of a hardware processor include a microcontroller, a microprocessor, one or more central processing unit cores, graphical processing units cores (GPU), an application-specific integrated circuit (ASIC), a field programmable gate array (FPGA), other forms or types of hardware or electronic circuitry, and the like. Based upon the disclosure provided herein, one of ordinary skill in the art will recognize a variety of processing resources that may be used in relation to different embodiments.

As used herein, an “Ear Appliance” generally refers to a device or system, including one or more sensors within a housing, that is designed so as to be supported by or mounted on a user's (or wearer's) ear. As described herein, depending on the particular implementation, an Ear Appliance may additionally include, among other things, mechanisms for receiving verbal commands and/or detecting head gestures from/of the user. In some examples, the sole point of attachment of an Ear Appliance to a user is via an associated ear mount that engages an ear of the user.

As used herein, a “visual spectrum imager” or simply an “imager” generally refers to an imaging device that captures light within the human-visible spectrum, typically ranging f40 m 400 to 700 nanometers. Non-limiting examples of imagers include digital or analog cameras and digital or analog video cameras having various fields of view.

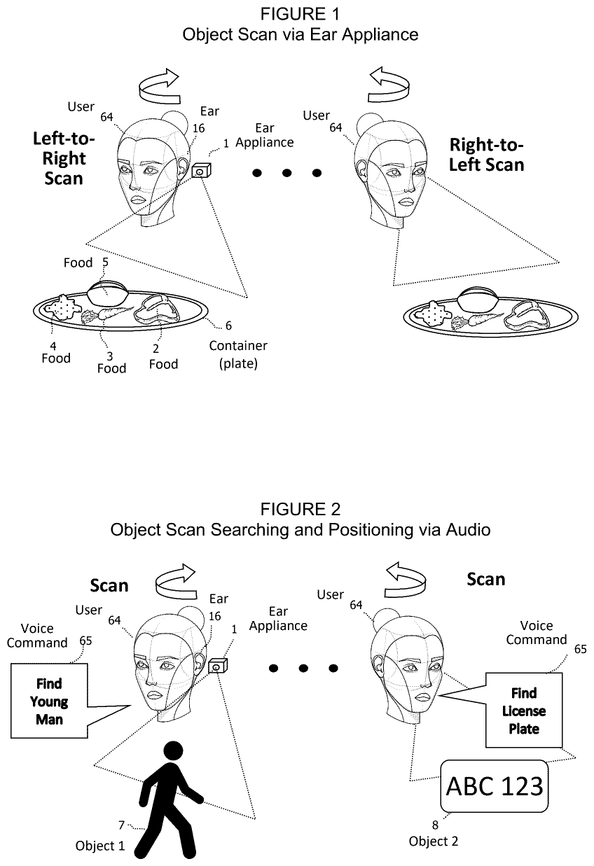

FIG. 1 illustrates an Ear Appliance 1 designed to only attach to an Ear 16 and specifically scan food in accordance with an embodiment of the present disclosure. In the context of the present example, a single Ear Appliance 1 resides in or on either ear of a User 64 and does not rely upon support from the head of a User 64. The User 64 invokes the use of the Ear Appliance 1 either through an audio command to which the Ear Appliance 1 responds or alternatively with a specific gesture of the User's 64 head. Either way, in this embodiment, the User 64 invokes the Ear Appliance 1 to initiate recording (e.g., video) which may make use of movement by the User 64 of their head to scan the field of view in front of the User 64. For conventional imaging sensors, it is generally required that a User 64 have access to a display to keep an object of interest in the imager's field of view. However, a function provided by Ear Appliance 1 is the ability of the Ear Appliance 1 to guide the User 64 throughout the scanning process via audio or haptic feedback and without the need for a display. As shown in FIG. 1, the User 64 looks at a plate 6 of food and swivels their head back-and-forth to create a video to capture not only food 2,3,4,5 but the Container 6 that it resides in. The individual images comprising a sequence of images of an object can be used to construct a point cloud of the object and consequently can be used to estimate the volume of the objects. The motion of a User's 64 head, with the attached Ear Appliance 1, may or may not be specifically guided by the Ear Appliance 1 through audio feedback. In another example, the Ear Appliance can be directed to scan, in the distance, objects of interest (e.g., particular stores, parking spaces, books on a shelf, etc.).

FIG. 2 illustrates a single Ear Appliance 1 which is directed through Voice Commands 65 to search for and identify specific objects in accordance with an embodiment of the present disclosure. For example, in one case, the Ear Appliance 1 may be directed to “Find Young Man”. In another case, the Ear Appliance 1 is directed to “Find License Plate”. In one embodiment, the User 64 purposely scans (moves their head) attempting to find the desired object. In another embodiment, the Ear Appliance 1 remains in “search” mode while the User 64 goes about their business. When the requested object is found, the Ear Appliance may then notify the User 64. In one case, the notification is through an audio alert into the user's Ear 16. In another case, the User 64 may be notified through a haptic event (i.e., vibrations). Furthermore, once a requested object is identified, the Ear Appliance 1 may provide the User 64 with a direction vector as to where the object is in relation to the position of the User's 64 head. In one embodiment, the Ear Appliance 1 has a single sensor (visible imager) facing forward towards where the User's 64 eye “sees”. In another embodiment, the Ear Appliance 1 comprises both front facing sensor and a rear facing sensors for scanning. This is particularly useful for security applications. In another embodiment, a side facing sensor on the Ear Appliance 1 scans sideways which is useful for searching for things while a user is walking past objects (thereby eliminating the need for the User 64 to constantly swivel their head).

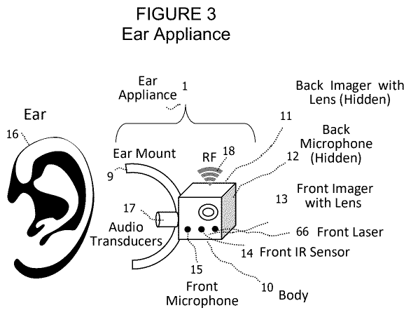

FIG. 3 illustrates an Ear Appliance 1 in accordance with an embodiment of the present disclosure. In this embodiment, the Ear Appliance 1 is comprised of an Ear Mount 9, designed to attach the Ear Appliance 1 to the Ear 16 securely. The Ear Mount 9 may or may not be permanently attached to the Ear Appliance 1. This embodiment also comprises an Audio Transducer 17 thereby providing a method for the User 64 to receive information from the Ear Appliance 1. In this example, the Ear Appliance 1 is shown further including a set of one or more forward-facing sensors, including, but not limited to a first microphone 15, visual image sensor 13, a first Front IR 14 Sensor and a first Front Laser 14. Alternatively, or additionally, the Ear Appliance 1 may also include a rear-facing visual sensor (e.g., imager with a lens); a rear facing microphone and rear facing IR sensors and lasers. Ear Appliances 1 may comprise wired or wireless RF 18 connectivity to other devices. Also, an Ear Appliance 1 may be standalone without needing network connectivity or alternatively rely upon network computing resources to operate.

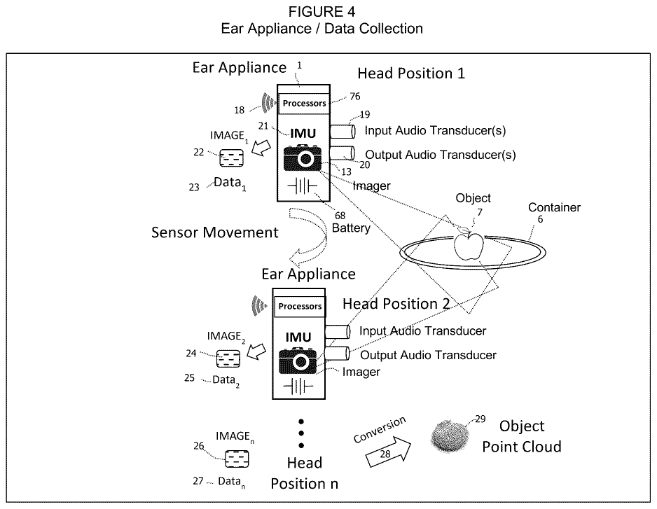

FIG. 4 illustrates various components comprising an Ear Appliance 1 and a simple data collection sequence in accordance with an embodiment of the present disclosure. This embodiment of an Ear Appliance 1 comprises one or more data and signals processors 76, an Inertial Measurement Unit (IMU) 21, a visible light imager with a lens 13, an Input Audio Transducer 19 and an Output Audio Transducer 20 and RF 18 capabilities for communications, location determination and radar. The Ear Appliance 1 also comprises a Battery 68. The IMU 21 provides a means by which a head gesture can power up, power down or initiate compute and sensor actions in addition to general operational commands of the Ear Appliance 1. IMUs 21 may also provide locations. GPS receivers may similarly provide locations. Processors 21 provide both compute and storage capabilities for the operation of the Ear Appliance 1. The Input/Output Audio Transducers 19, 20 provide a communication channel for the User 64 to guide and receive information as to the operation of the Ear Appliance 1. The RF 18 capability may comprise Wi-Fi, Bluetooth, GPS or other electromagnetic methods for identifying the location of an Ear Appliance 1 in addition to communications.

In one embodiment, the Ear Appliance 1 is physically supported predominantly by the ear to which it is associated. In another embodiment, the Ear Appliance may be supported predominantly from a friction fit of the Ear Appliance 1 into an ear canal.

While a predominant use case of an Ear Appliance sensor is envisioned to be the scanning and recording of images in the visible spectrum, it is anticipated that other spectrums may be embodied (e.g., infra-red, 60 GHz, etc.). Also, embodiments may incorporate multiple different and same sensors pointing in multiple directions: 1)front; 2) back; 3) up; 4) down and 5) side.

Still referring to FIG. 4, a non-limiting example of a scan sequence is presented. At Head Position 1, a head gesture sensed by the IMU 21 powers up the Imager 13 and any other elements of the Ear Appliance 1 which may be in idle power mode or off. Then, the Ear Appliance 1, via the Output Audio Transducer 20 informs the User 64 (wearing the Ear Appliance) to start a scan using a haptic or audio cue signal (e.g., an audio voice command/instruction or signal). An example of an audio instruction may be as simple as audio “go,” a chime, or a detailed description of what the user must do to perform the scan. The User 64 then starts moving their head. As a result, the IMU 21 detects the head movement and enables the Imager 13 to gather Images 22, 24, 26 and Data 23, 25, 27 (e.g., position, time, etc.). The Ear Appliance 1 may also provide audio guidance information to the User 64 as the scan is taking place. When sufficient information is recorded, the Ear Appliance 1 may issue an audio message to the User 64 or via a haptic actuator to notify the User 64. The collected data may be used for Artificial Intelligence classifications, segmentation or other purposes. An AI Agent may interpret the incoming data and make additional suggestions of scanning. In one example, processing the data may involve creating three-dimensional (3D) models (e.g., “point clouds” 29) of a scanned Object 7. An Ear Appliance 1 with multiple input/output audio transducers enables a variety of functions to be performed. This includes, but is not limited to an ability for a person nearby the wearer of the Ear Appliance 1 to listen to audio content (i.e., speaker mode), to provide noise cancellation of surrounding audio, to provide audio triangulation location assessments of an object or the User and may provide earplug type attenuation capabilities. For example, having an Ear Appliance 1 in both ears reduces the natural audio level of sound waves arriving at the ear drums. In high decibel audio environments, the Ear Appliance 1 may be instructed, through gestures, to incrementally attenuate the sound reaching the eardrum because the Ear Appliance 1 takes in the ambient sound and processes it for the right level for the user to comfortably hear it. Furthermore, for highly predictable noise sources, an Ear Appliance 1 can take samples and then use the ambient noise profile to create appropriate filtered audio (eliminating high decibel audio) back to the user. This capability is useful in environments where users must often transition between ear plug mode and non-ear plug mode.

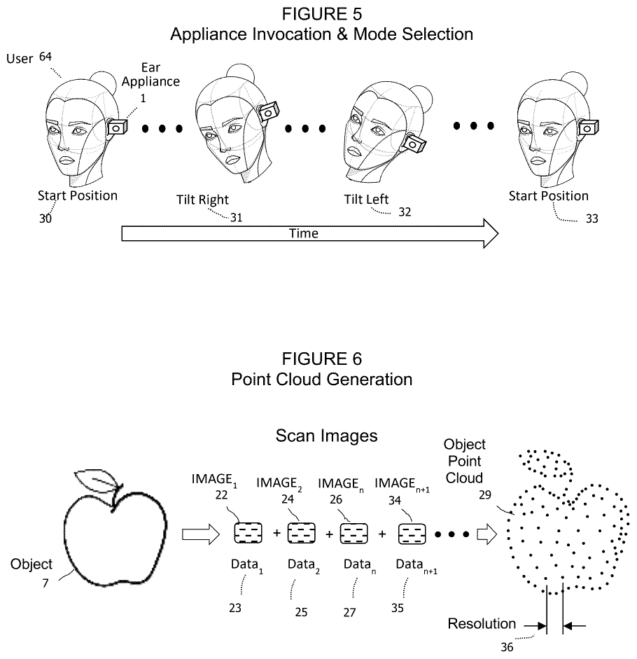

FIG. 5 illustrates an Ear Appliance 1 invocation through a head gesture in accordance with an embodiment of the present disclosure. In this example, the User's 64 head starts in a face-forward position 30. The User 64 tilts their head to the right 31 and then to the left 32 within a short amount of time before returning to a vertical position 33. There are situations where it is necessary to remain silent or quiet. Instead of relying upon a user's voice to command/guide the Ear Appliance 1, specific head movements generate IMU signals the Ear Appliance 1 can use to command different operations. For example, to maintain low power consumption, the Ear Appliance 1 may keep its sensors powered down until needed. A simple specific gesture (e.g., tilting the head back and forth) may power up dormant devices and circuits in the Ear Appliance 1. Classic human gestures like nodding a head up and down for “yes” and side to side for “no” may be incorporated for controlling the Ear Appliance 1. These gestures may be programmed or adjusted by the User 64 to associate them with specific actions. Users 64 may associate specific (i.e., train) head gestures for personal Ear Appliance 1 tasks. This would include, but is not limited to initiating a phone call, sending a text message, alerting a nearby wearer of an Ear Appliance 1 or citing the time of day.

FIG. 6 illustrates an Ear Appliance 1 sequence of image and data gathering for generating 3D point clouds through head movement reconstruction in accordance with an embodiment of the present disclosure. In this example, a series of still images (extracted from video for from distinct still images) 22, 24, 26, 34, along with spatial data (e.g., information from an imager's depth calculator or an IMU) 23, 25, 27, 35 is used to create a 3D or point cloud model of an object. In FIG. 6, this Object 7 is an Apple. The processes of constructing 3D point clouds 29 is not limited to any single method of computation and may simultaneously compute 3D point clouds for multiple objects simultaneously.

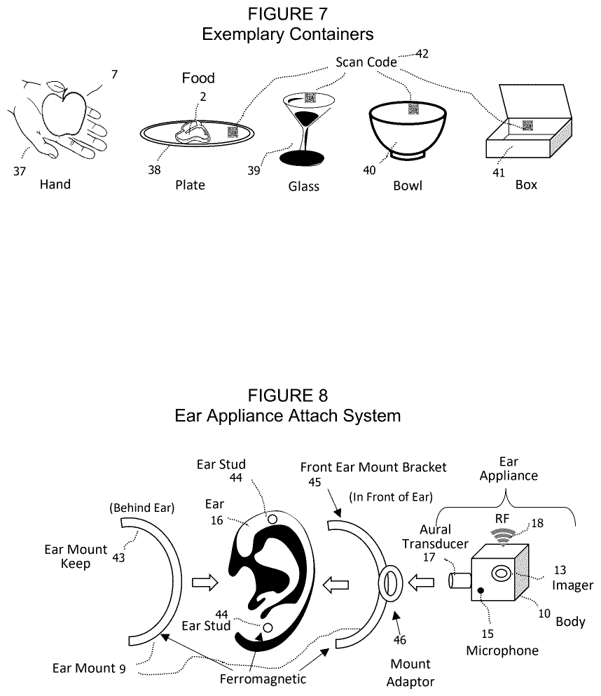

FIG. 7 illustrates exemplary Containers (Hand 37, Plate 38, Glass 39, Bowl, 40, Box 41) for holding classes of objects in accordance with an embodiment of the present disclosure. In some examples, when scanning objects, an Ear Appliance 1 may discern Containers (37, 38, 39, 40, 41) from Objects 7, 2 in or on the Containers 37, 38, 39, 40, 41. The discernment may be from machine-learned models which are trained to identify Containers and their classes of objects. In other examples, the Ear Appliance 1 may make use of a scan code 42 (e.g., a QR code, bar code or the like) on Containers which provide for container information that may be helpful to the Ear Appliance 1 for determining volume. These scan codes may include, but are not limited to dimensions of the container, volume of the container, weight of the container, typical class of objects related to the container and manufacturer.

FIG. 8 illustrates an Ear Appliance 1 attachment system in accordance with an embodiment of the present disclosure. Existing audio earpieces rely upon various methods for securing them to ears. Some rely upon wedging the earpiece into the ear canal. Others rely upon a shaped clip which rests upon the cartilage protruding from the head to connect to the ear itself. FIG. 8 shows a clamp mechanism for attaching an Ear Appliance 1 to an Ear 16. In this example, the clamp mechanism is comprised of a behind-the-ear Ear Mount Keep 43 and a Front Ear Mount Bracket 45 which is arranged on the outer surfaces of the ear. Through magnetism, the two pieces are drawn together to provide a reasonable clamping force against the Ear 16 thereby supporting the Ear Appliance 1. An alternate embodiment is to eliminate the Ear Mount Keep 43 and instead, mount ferromagnetic Ear Studs 44 in the ear for the Front Ear Mount Bracket in front to attach to the Ear 16 through magnetic force. This system of magnetic clamping may be permanently integrated into the Ear Appliance 1 itself or alternatively, it may be attached to the Ear Appliance 1 through a Mount Adaptor 46. This modular approach allows a User 64 to optimize the mounting of an Ear Appliance 1 through the selection of different sized ear mounting pieces. The Mount Adapter 46 may be of varying fixed length according to how a User 64 may wish the Ear Appliance 1 to be situated in relationship to the Ear 16. Alternatively, the Mount Adaptor 46 may comprise an actuator which repositions the Ear Appliance 1 with respect to its position to the ear and is controlled by the Ear Appliance 1 via mechatronics This telescoping function facilitates a greater field of view (by getting further away from the head) which reduces the requirement for head swiveling to capture scans.

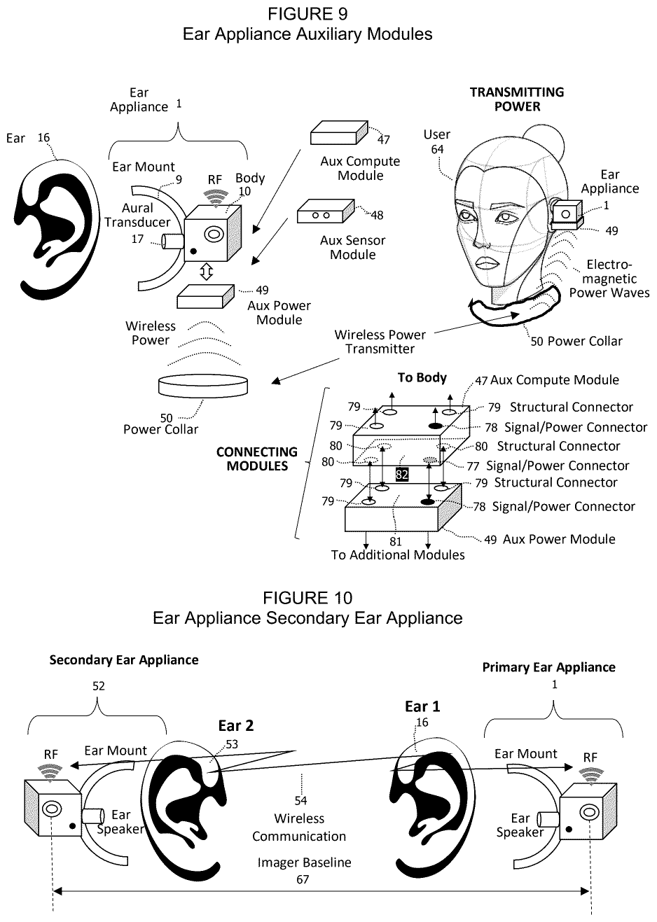

FIG. 9 illustrates Ear Appliance 1 auxiliary modules in accordance with various embodiments of the present disclosure. A challenge with small devices is battery longevity. Generally, the smaller the device, the more comfortable the device. FIG. 9 shows examples of Auxiliary modules 47, 48, 49 which can easily be clipped or attached to an Ear Appliance 1 to extend its capabilities. One module may provide additional battery power. A different module may provide additional compute power and memory 47. Another module may comprise a wireless power receiver for receiving transmitted power from another place on the user 64. Another module may provide additional sensors 48. FIG. 9 illustrates a Power Collar 50 capable of directing electrical energy towards an Ear Appliance 1 which can receive this power. Alternatively, a power transmitter may be incorporated into a head cover (e.g., hat, band, etc.). Auxiliary modules may comprise but are not limited to additional computing power, additional sensors, alternate communications links (e.g., laser, etc.) location modules or specific AI agents.

FIG. 9 further illustrates an embodiment of physical, signal and power connections between modules (CONNECTING MODULES). Modules 47, 49 may comprise parallel surfaces 81, 82 constructed to facilitate connection between them. As shown, there are three Structural Connectors 79 and a single Signal/Power Connector 78 on a surface 81 of an Aux Power Module 49. Similarly, there are three Structural Connectors 80 and a single Signal/Power Connector 77 on a surface 82 of an Aux Compute Module 47. The Connectors 77, 78, 79, 80 are arranged such that they allow for connection between Modules 47, 49 when the Modules are aligned and brought together. The Structural Connectors 79, 80 provide the means for Modules 47, 49 to effectively become physically coupled. The order and number of Modules which may be connected together is not limited. Structural Connectors 79, 80 may be the same or different. For example, in one embodiment, a Structural Connector 79 on a surface of an Aux Power Module 49 may be a male plug design, whereas the corresponding position of the Structural Connector 80 on an Aux Compute Module 47 may be a socket which captures the plug through the use of friction. Alternatively, Structural Connectors 79, 80 may be a uni-design enabling connection without regard to male/female construction. In another embodiment, Structural Connectors 79, 80 may be magnetic. While Signal/Power Connectors 77, 78 may comprise both signal and power, signals and power may be separated into their own connector pairs. A significant advantage of the auxiliary modules is the ability to attach or detach modules to the Ear Appliance 1 without a User 16 removing the Ear Appliance 1 from their Ear 16. Signal/Power Connectors 77, 78 may convey signals through any means but not limited to light, electricity or radio frequencies.

FIG. 10 illustrates direct Wireless Communication 54 between multiple Ear Appliances 1, 52 in accordance with an embodiment of the present disclosure. There are use cases where having stereoscopic photogrammetry may be desired. In such cases, a User 64 may choose to attach both left and right versions of an Ear Appliance 1, 52 wherein one becomes a master (primary) and the other becomes a slave (secondary). Operation may be coordinated directly between the two Ear Appliances 1, 52 for taking sensor data (images, etc.). Furthermore, it is envisioned that more than two Ear Appliances may be connected, for example, through mesh networking. Consequently, groups of users may have coordinated scans of containers, objects and structures (e.g., buildings, cars and rooms). Coordination among users may be orchestrated through the processors in each user's Ear Appliance 1 and comprises but is not limited to directing the sensor data collection of an object selected by the user from different perspectives. For example, a User 64, within a group of users may direct his/her Ear Appliance 1 to search for a particular item (e.g., a purse). This directive may be transmitted to all Ear Appliances 1 worn by other users in a venue. As a result, all wearers of Ear Appliances 1 can scan an area (by head movements). If a desired object is found, a notification to every user may be tendered (e.g., via audio or haptics) via RF communication 54 between the Ear Appliances 1. Furthermore, as cited in the description associated with FIG. 4, location directions may be synthesized from the RF capabilities (Radar, GPS, Lidar, etc.) and individual instructions or guidance (e.g., direction vectors) may be given to each user as to where, in reference to their position they need to adjust the position of their head to see the object. For example, if a group of five users wearing Ear Appliances 1 are in a room and their Ear Appliances 1 have all been directed to search for a “hat” then when a user's Ear Appliance 1 identifies a hat, the necessary information may be generated in the network of Ear Appliance 1 users for a specific individual Ear Appliance to inform each user of where to turn their head to see the “hat”.

In the case where one user has both a left and right Ear Appliance 1, the user may invoke simultaneous image captures from both Ear Appliances thereby creating a stereoscopic set of images. These images can be used to generate a 3-dimensional point 1, 52 cloud from objects in the image using standard point cloud generation techniques without scanning. When a Primary 1 and Secondary 52 Ear Appliances are used, a calibration can take place wherein an object of known size is captured by both imagers (simultaneously with the head remaining in a fixed position). From this, the stereoscopic Imager Baseline 67 (distance between the Primary and Secondary Ear Appliance may be calculated using trigonometry for individual wearers of the Left and Right Ear Appliances 1, 52. Consequently, subsequent stereo images taken by the left and right Ear Appliances with the known baseline can calculate not only 3D images but distances and directions to objects from a User 64. When stereoscopic images are captured at a known steady cadence (e.g., once a second), objects in the field of view can be identified and tracked as to the rate at which they are coming towards or receding from the User 64. The object identified may be directed by the User 64 through an audio command. For example, the User 64 may direct the Ear Appliances 1, 52 to search for and lock onto a man (a type of object) in the User's 64 rear field of view (providing the Ear Appliances 1, 52 comprise rear facing imagers). The Ear Appliances 1, 52 may use, but is not limited to, AI technologies of classification for the identification of objects. Once an object is being tracked, the Ear Appliance(s) may use the calculated position of the object to inform the user. This comprises, but is not limited to, rate of approach or departure from the user, general location of the object in terms of direction (e.g., 10 o'clock, 6 o'clock, etc.) or height of the object. This position and movement data can further be used by the Ear Appliance 1 to provide alerts to the User 64. For example, the User 64 may set an alert (either audio or haptic) to inform the User 64 of a man approaching from the rear if the man is approaching at a threshold rate. In another example, the User 64 may specify a specific human (man or woman) from a database of humans (facial recognition databases) to be identified by the Ear Appliance(s) 1, 52 and notify the User 64. In another example, the user may specify one or more human attributes (e.g., height, hair length, sex, color and/or weight) to be identified.

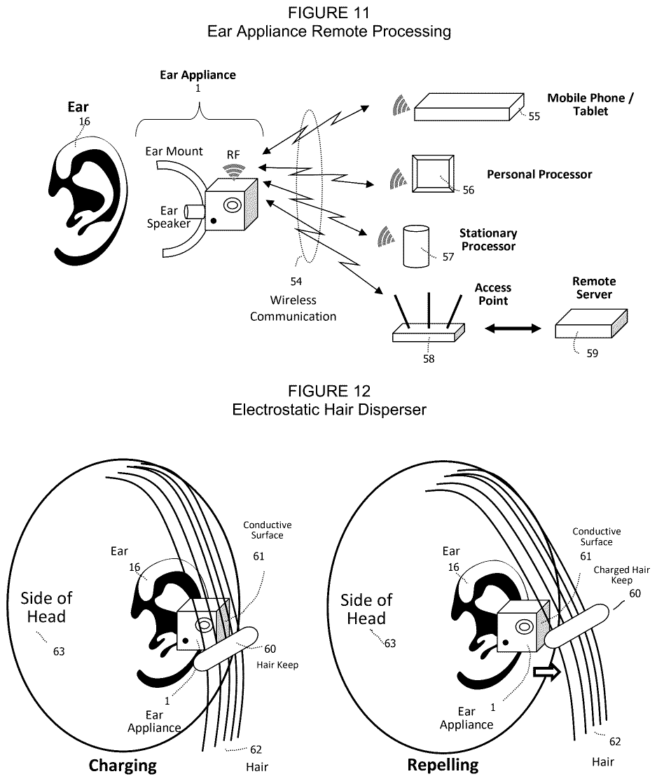

FIG. 11 illustrates Ear Appliance 1 remote processing in accordance with an embodiment of the present disclosure. Some Ear Appliance 1 implementations may rely entirely upon compute processing within them. Alternatively, Ear Appliance processing may rely entirely upon remote processing wherein the Ear Appliance 1 is comprised of sensors with minimal processing to collect sensor data and forward it to remote processers. These remote processors include but are not limited to Mobile Phones 55, Tablets 55, Personal Processors (either attached or detached from a person) 56, Stationary Processors 57 or Remote Servers 59 via Access Point communication 58. Split processing, wherein a portion of the processing is performed within the Ear Appliance 1 and another portion is performed remotely (55, 56, 57, 59) is also anticipated.

FIG. 12 illustrates an electrostatic Ear Appliance hair avoider in accordance with an embodiment of the present disclosure. Not all users of an Ear Appliance have short hair. There are use cases where people with long hair need to physically intervene and adjust their hair away from Ear Appliance 1 sensors to achieve an unobstructed field of view. To avoid user physical intervention, in some examples, an Ear Appliance comprises a Conductive Surfaces 61 capable of imparting electrical charges proximate to nearby hair. In one example, the hair has a permanently charged Hair Keep 60 attached to the hair proximate to the Ear Appliance 1. When it is time for the Ear Appliance 1 to take sensor data, the conductive surface of the Ear Appliance is charged to the same electrostatic potential as the Hair Keep 60 thereby repelling it out of the way of the Ear Appliance 1 sensors. Once the Ear Appliance 1 is finished taking sensor data, the Ear Appliance 1 reverses the charge on the Conductive Surface thereby pulling the hair back next to the Ear Appliance 1.

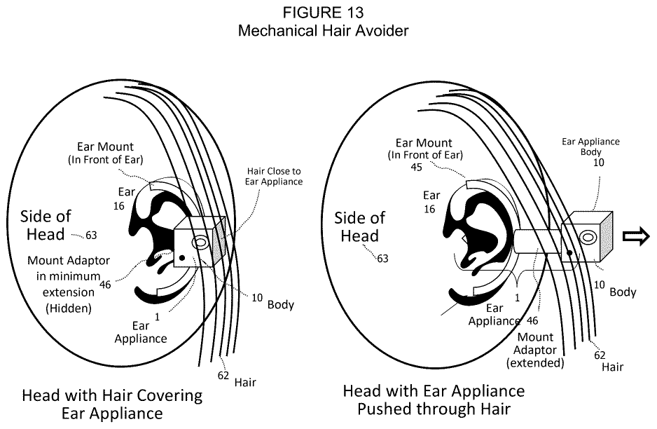

FIG. 13 illustrates a mechanical Ear Appliance hair avoider in accordance with an embodiment of the present disclosure. In this example, a mechanical method for avoiding Ear Appliance 1 sensor blocking is described. In one embodiment, an Ear Appliance (e.g., like the one described in FIG. 8), for example, with a Mount Adapter that is adjustable in length, (e.g., via electric actuation) provides for the movement of the Ear Appliance 1 away from the Side of Head 63 and Hair 62. The body of the Ear Appliance may be designed to guide hair away from blocking the Ear Appliance sensors as the Ear Appliance Body is extended away from the head.

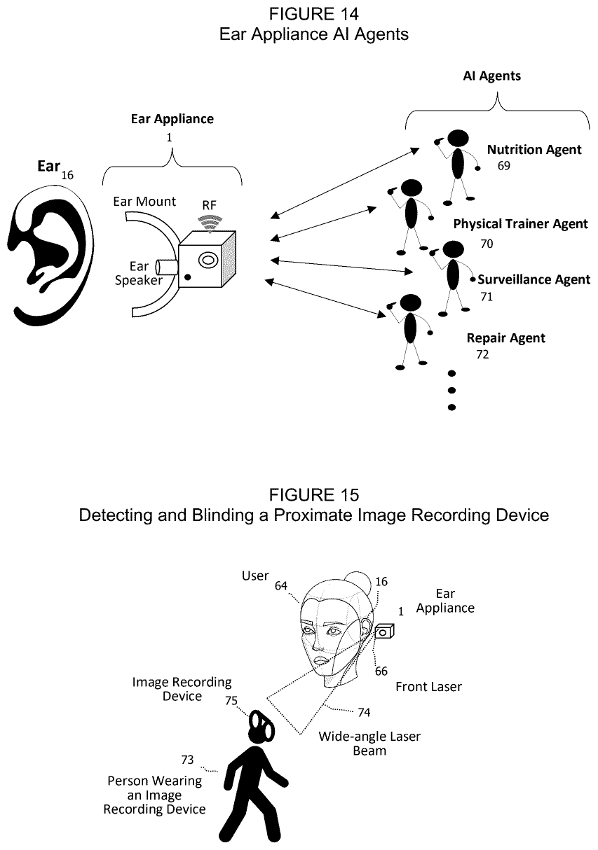

FIG. 14 illustrates the use of Ear Appliance AI Agents in accordance with an embodiment of the present disclosure. In this example, the Ear Appliance 1, with its simultaneous audio, visual and gesture capabilities, not only for an individual User 64 but for a group of Users 64, is further enhanced by the use of AI Agents. A first class of AI Agent may include those that any common user may wish to take advantage of as a wearer of the Ear Appliance 1. For example, a generic AI Agent which identifies, and tracks food consumed can be made available to any user (Nutrition Agent 69). Another example would be to scan a printed code (e.g., bar code, UPC, QR, etc.) and inform the User 64. A second class of AI Agent may include those which are specifically trained to a user's profile (supplied by the User 1) and the sensor capabilities comprising a particular Ear Appliance 1. As cited in the description of FIG. 9 (Auxiliary Modules), additional modules may be added to the Ear Appliance 1 and specifically trained for a use case for the user. For example, an entire classification engine module may be attached to an Ear Appliance which comprises both a specific classification module for food and nutrition with an AI Agent tailored to the specific nutrition needs of the user. A substantial benefit of this approach is eliminating the need for online connectivity with networking and server delays. A Surveillance Agent 71 comprising the ability to identify a person wearing a device capable of photographing or video recording the User 1 may alert the User 1 to the possibility of being recorded by someone proximate to the User 1. The alert may be audio or haptic and may include a general description of the direction and position of that person (e.g., 10 o'clock, 3 o'clock).

FIG. 15 illustrates the use of an Ear Appliance 1 to detect and blind proximate Image Recording Devices 75. An Ear Appliance 1, equipped with a Laser 66, can be directed towards a Person Wearing an Image Recording Device 73 to temporarily render its imager ineffective. When instructed by the User 64, the Ear Appliance 1 enters a mode of searching for image recording devices within range of the User 64. Most prominently these image recording devices may be “smart glasses” or chest devices. Once a potential recording device has been identified, a Wide-angle Laser Beam 74 visible light laser is directed towards the Image Recording Device 75 by the User 64 thereby rendering the Image Recording Device 75 ineffective in capturing the image of the User 64. Ineffective may denote a complete inability of an Image Recording Device 75 to capture a valid image but also includes degradation of the Image Recording Device 75 to capture a quality image. The Ear Appliance 1 may automatically initiate the Wide-angle Laser Beam 74 upon detecting an image recording device or wait for a command by the User 64 to immediately enable the Wide angle Laser Beam 74. The Ear Appliance 1 may further increase the ability to blind the Image Recording Device 75 by modulating the Wide-angle Laser Beam 74.

A powerful embodiment of the Ear Appliance is the capability to download proximate object classifiers and their associated data for the user. As an example, a user may enter a restaurant for a meal. The Ear Appliance 1 for that user can download (either automatically or manually) the restaurant's menu (including detailed nutritional and portion information of the menu items). This would include AI classification and segmentation models which were generated by the restaurant from models built by them as part of their menu creation. Then, when a User 1 receives their food, the Ear Appliance 1, using a scan by the User 1, may then capture the meal consumed by the User 64. A substantial benefit of this approach is limiting the available objects in a classifier to only those that are available in that location. This helps to eliminate the false positive classifications of objects from a large, generalized, AI classifier.

Embodiments of the present disclosure include various steps, which have been described above. The steps may be performed by hardware components or may be embodied in machine-executable instructions, which may be used to cause one or more processing resources (e.g., one or more general-purpose or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more processors within an Ear Appliance having storage therein or having network access to computer program(s) coded in accordance with various methods described herein, and the method steps associated with embodiments of the present disclosure may be accomplished by modules, routines, subroutines, or subparts of a computer program product.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks. Volatile media includes dynamic memory, such as a main memory of a processor. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise a bus (e.g., a system bus). Transmission media can also take the form of acoustic or light waves, such as those generated during radio-wave and infra-red data communications.

Various forms of media may be involved in carrying one or more sequences of one or more instructions to the one or more processors for execution. For example, the instructions may initially be carried on a magnetic disk or solid state drive of a remote computer. The remote computer can load the instructions into its dynamic memory and transfer the instructions to an Ear Appliance via wireless means. A wireless receiver local to the Ear Appliance can receive the wireless transmitted data and persist the data to local memory (e.g., a processor main memory) and/or local storage, from which the one or more processors of the Ear Appliance may retrieve and execute the instructions. The instructions received by main memory may optionally be stored on a storage device either before or after execution by the one or more processors.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An ear appliance comprising:
an imager;
a microphone;
a speaker;
a processing resource; and
instructions that when executed by the processing resource cause the ear appliance to record images and audio on the ear appliance, wherein the ear appliance attaches only to a first ear of a user.

2. The ear appliance of claim 1, further comprising an Inertial Measurement Unit (IMU) operable to convert head gestures into specific actions of the ear appliance.

3. The ear appliance of claim 2, wherein the instructions further cause the ear appliance to utilize data generated by the imager and the IMU to create three-dimensional (3D) images of objects.

4. The ear appliance of claim 1, wherein the instructions further cause the ear appliance to create stereoscopic images of objects by interacting with another ear appliance of the user and attached to a second ear of the user.

5. The ear appliance of claim 1, wherein the instructions further cause the ear appliance to perform a common search for an object by networking together the ear appliance with one or more ear appliances worn by one or more other users.

6. The ear appliance of claim 1, wherein the instructions further cause the ear appliance to:
detect an object;
convey to the user where the object is in space; and
convey to the user a velocity at which the object is approaching or departing from the user.

7. The ear appliance of claim 2, wherein the instructions further cause the ear appliance to increase or decrease power consumption of the ear appliance through respective gestures made by the user.

8. The ear appliance of claim 1, wherein the instructions further cause the ear appliance to detect existence an image recording device proximate to the user.

9. The ear appliance of claim 8, further comprising a wide-angle laser, wherein the instructions further cause the ear appliance to automatically initiate the wide-angle laser after detecting existence of the proximate image recording device.

10. The ear appliance of claim 8, wherein the instructions further cause the ear appliance to notify the user of the existence of the proximate image recording device and a location thereof.

11. The ear appliance of claim 1, further comprising electrostatic means for pushing hair away from the ear appliance.

12. The ear appliance of claim 1, further comprising mechanical means for pushing hair of the user away from the ear appliance or pushing the ear appliance through the hair of the user.

13. An ear appliance comprising:
an imager;
a microphone;
a speaker;
a processing resource;
instructions that when executed by the processing resource cause the ear appliance to record images and audio on the ear appliance, wherein the ear appliance attaches only to a first ear of a user; and
coupling means though which one or more additional or auxiliary modules may be added to increase functionality of the ear appliance.

14. The ear appliance of claim 13, further comprising a battery module coupled to the ear appliance via the coupling means.

15. The ear appliance of claim 13, further comprising a processor module coupled to the ear appliance via the coupling means.

16. The ear appliance of claim 13, further comprising an additional sensor module coupled to the ear appliance via the coupling means.
